(19) United States
(12) Patent Application Publication
(10) Pub. No.: US 2025/0363418 A1
(43) Pub. Date: Nov. 27, 2025

(54) PRIVACY-SENSITIVE TRAINING OF MACHINE LEARNING MODELS

(71) Applicant: GDM Holding LLC, Mountain View, CA (US)

(72) Inventors: Christopher Choquette Choo, Sunnyvale, CA (US); Abhradeep Guha Thakurta, Los Gatos, CA (US); Arun Ganesh, Seattle, WA (US)

(21) Appl. No.: 19/215,262

(22) Filed: May 21, 2025

Related U.S. Application Data
(60) Provisional application No. 63/650,892, filed on May 22, 2024.

(51) Int. Cl. G06N 20/00; G06F 21/62

(52) U.S. Cl. CPC G06N 20/00; G06F 21/6218

(57) ABSTRACT

System and method for privacy-sensitive training of machine learning models. The method comprises, at each of a plurality of training iterations: obtaining a respective batch of training data items that are used to determine a gradient of the objective function for the current training iteration; and updating values of the model parameters using the gradient of the objective function for the current training iteration and noise values, comprising: updating a set of supplementary values of the parameters using the gradient of the objective function for the current training iteration in accordance with a first learning rate; updating the values of the parameters using the gradient of the objective function for the current training iteration in accordance with a second learning rate; and further updating the values of the parameters by combining the values of the model parameters with the supplementary values of the parameters.

### CROSS-REFERENCE TO RELATED APPLICATION

This application claims priority under 35 U.S.C. 119 to Provisional Application No. 63/650,892, filed May 22, 2024, which is incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a training system implemented as computer programs on one or more computers in one or more locations that performs privacy- sensitive training of a machine learning model.

The training system and methods described in this specification can be used to

train a machine learning model to perform a machine learning task using a privacy- sensitive training technique that mitigates the risk of privacy attacks. A privacy attack on a machine learning model can refer to operations performed to extract information about the set of training data used to train the machine learning model, e.g., in the form of revealing individual training examples (e.g., including individual inputs to the machine learning model) that were used during the training of the machine learning model. Privacy attacks can result in the exposure of confidential information. The risk of privacy attacks, if left unaddressed, can limit the deployment of machine learning models that are trained on sensitive datasets.

In one aspect, there is therefore provided a method performed by one or more computers for privacy-sensitive training of a machine learning model. The machine learning model comprises a set of model parameters, values of which are updated over a plurality of training iterations to optimize an objective function. The method comprises, at each of the training iterations: obtaining a respective batch of training data items; using the training data items in the batch to determine a gradient of the objective function for the current training iteration; obtaining a respective plurality of noise values; and updating the values of the model parameters using the gradient of the objective function for the current training iteration and the plurality of noise values.

Updating the values of the model parameters using the gradient of the objective function for the current training iteration can comprise: updating a set of supplementary values of the model parameters using the gradient of the objective function for the current training iteration in accordance with a first learning rate; updating the values of the model parameters using the gradient of the objective function for the current training iteration in accordance with a second learning rate that differs from the first learning rate (e.g. is less than); and further updating the values of the model parameters by combining the values of the model parameters with the supplementary values of the model parameters.

Using the training data items in the batch to determine a gradient of the objective function for the current training iteration may comprise, at each of the training iterations except the first, determining the gradient of the objective function for the current training iteration by updating the gradient of the objective function for the previous training iteration using the training data items in the batch for the current training iteration.

In some implementations, using the training data items in the batch to determine the gradient of the objective function for the current training iteration comprises: using the training data items in the batch to determine a first gradient of the objective function with respect to the model parameters in accordance with values of the model parameters as of the current training iteration. Determining the gradient of the objective function for the current training iteration by updating the gradient of the objective function for the previous training iteration using the training data items in the batch can comprise: using the training data items in the batch to determine a second gradient of the objective function with respect to the model parameters in accordance with values of the model parameters as of the previous training iteration; and combining the gradient of the objective function for the previous training iteration with the first gradient and the second gradient to obtain the gradient for the current training iteration.

For example, a gradient update can be determined from a difference between the first gradient and the second gradient, and the gradient update combined with the gradient for the previous training iteration to obtain the gradient for the current training iteration.

In some implementations, for each training iteration except the first, the set of supplementary values of the model parameters that is updated in the current training iteration is the set of the supplementary values of the model parameters following the update of the previous training iteration. That is, the set of supplementary values of the model parameters is maintained and updated over the training iterations.

In general, as referred to herein, a gradient of the objective function can comprise respective gradient values that each correspond to one of the model parameters, such that each value of the model parameter can be updated using (e.g. combined with) the corresponding gradient value. Similarly, the plurality of noise values can comprise a respective noise value for each of the model parameters, such that each value of the model parameter can be updated (e.g. combined with) the corresponding noise value.

Also described herein is a method performed by one or more computers for privacy-sensitive training of a machine learning model. The machine learning model comprises a set of model parameters, values of which are updated over a plurality of training iterations to optimize an objective function. The method comprises, at each of the training iterations. the method comprising, at each of the training iterations: obtaining a respective batch of training data items; using the training data items in the batch to determine a gradient of the objective function for the current training iteration; obtaining a respective plurality of noise values; and updating the values of the model parameters using the gradient of the objective function for the current training iteration and the plurality of noise values.

The subject matter described in this specification can be implemented in particular embodiments so as to realize one or more of the following advantages.

The training system and methods described in the present disclosure may allow

privacy-sensitive training of a machine learning model in a computationally efficient manner. That is, the machine learning model can be trained to perform a machine learning task without the trained machine learning model being vulnerable to privacy attacks. Thus, sensitive training data, such as medical data, can be kept substantially private.

Many algorithms for differentially private (DP) machine learning are based on stochastic gradient descent (SGD), for example, DP-SGD, in which the training data used to train the machine learning model is divided into a plurality of batches and each batch is used to estimate a gradient for updating values of the machine learning model. These algorithms achieve DP (i.e. a differential privacy guarantee) by treating each gradient as an independent private query, such that a predetermined amount of noise is added to the gradient to ensure that the privacy loss for the gradient is below a required limit. By treating the gradients as independent, differential privacy methods that use SGD can “overpay” in privacy loss, which may cause the amount of noise added to the gradients of each batch to be greater than needed to achieve DP. One consequence of this issue is that the training data must typically be divided into a large number of (relatively small) batches when the machine learning model is trained by SGD, which can make training the machine learning model inefficient and/or less effective. For example, a large number of batches can be inefficient in cases where the parameters of the machine learning model are shared between multiple processor units during training, such as between hardware accelerator units, e.g. Graphics Processing Units (GPUs) or Tensor Processing Units (TPUs), or in federated learning environments where a central server coordinates training of the machine learning model by multiple client devices and has to distribute model parameters to the client devices.

The training methods and system described in the present disclosure can allow larger batch sizes to be used when training the machine learning model, which may reduce the computational resources, such as bandwidth and/or processor operations, required to train the machine learning model, whilst preserving a required level of differential privacy.

For example, by allowing larger batch sizes to be used, the present disclosure may reduce the amount of data (e.g. values of the model parameters) that needs to be transmitted from a server to one or more client devices, or from a processor to one or more hardware accelerator units, such that the client devices or hardware accelerator units can compute gradients of the objective function for batches of training data items. For example, the one or more client devices may store or otherwise be authorized to access training data items that include sensitive data (e.g. electronic medical record data) and there may be a requirement that the gradients of the objective function need to be computed locally, i.e. at the client device, as part of a federated learning process, for example. The one or more client devices may then determine the gradient for each batch of training data items locally, i.e. at the one or more client devices, and add noise to the gradient before sending the (noisy) gradient to the server for updating the values of the model parameters, or otherwise add the noise during a local updating of the values of the model parameters using the gradient before the updated values of the model parameters are sent to the server. In such cases, the training data items in the batches can remain private, e.g., such that the server is not able to extract any of the training data items from the noisy gradients or updated model parameters.

The training methods and system described in the present disclosure can also avoid issues arising from treating of each gradient determination as an independent private query. For example, by using recursively computed gradients (such as Stochastic Recursive Gradients, SRGs), i.e., determining the gradient as a sum of gradient updates, noise can be added to the gradients at an optimal rate whilst preserving the required level of differential privacy. Thus, the effect of the excessive noise on the training of the machine learning model can be mitigated, which can mean that increase the robustness and prediction accuracy of the machine learning model can be increased for a given amount of training data, or conversely, that less training data and/or computational resources, e.g., memory and computing power, may be required to achieve a given level of performance of the machine learning model.

Computation of gradients by SRGs can be performed in a computationally efficient manner in an number of ways, such as, for example, (i) computing the gradients for the training data items in a batch in parallel; and/or (ii) computing the gradients for the training data items using the values of the model parameters for the current training iteration in parallel with computing the gradients for the training data items using the values of the model parameters for the previous iteration.

The training methods and system described in the present disclosure can also accelerate training of the machine learning model whilst preserving the required level of differential privacy by coupling two gradient descent-based algorithms with different learning rates. As described in this specification, this approach has been found to be compatible with differential privacy. For example, acceleration can be achieved by updating a set of supplementary values of the model parameters over the training iterations using learning rates (i.e., scaling factors, which may vary between training iterations, that are applied to the gradient) that exceed the learning rate(s) used to update the values of the model parameters, and then further updating the values of the model parameters by combining the values of the model parameters with the updated supplementary values of the model parameters. Such an approach may enable more rapid convergence of the values of the model parameters such that fewer training data items and/or computational resources are needed to train the machine learning model to a particular level of accuracy. Larger batch sizes may also be used in such cases.

The privacy-sensitive training of the machine learning model can be understood as a privatized learning algorithm. In general, the privatized learning algorithm (i.e., training process) is a randomized learning algorithm that takes a set of training data as input and generates a set of model parameters of the machine learning model as output.

The privacy protection offered by the privatized learning algorithm is similar to one-way encryption that implement one-way functions, e.g., for private-key encryption, cryptographic hashing, etc. A one-way function is a function that is relatively easy to compute on every input but relatively hard to invert given the output of a random input, where “easy” and “hard” are in the computational complexity sense. The privatized learning algorithm may be understood in a similar sense: performing the privatized learning algorithm on a set of training data to generate optimized values of model parameters is relatively easy; whilst extracting a single training example from the training dataset given the optimized model parameters is relatively hard (or unfeasible) even if an adversary has full knowledge the privatized learning algorithm. Hence, the privatized learning algorithm provides a means of “encrypting” a training dataset that is used for training a machine learning model.

We do not state or imply here that a model ‘contains’ its training dataset in the sense that there is a copy or version of that dataset in the model. Rather, a model may include (“memorize”) attributes of its training data such that in certain cases it is statistically able to generate content that is a close approximation to elements of that training data when following rules and using such attributes. Content that is repeated in the training dataset many times is more likely to be among the content the model can be induced to closely approximate. However, the incidences of such close approximations are exceptionally rare and often are produced only through specific challenges designed to produce them.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system for privacy-sensitive training of a machine learning model.

FIG. 2 shows a flow diagram of an example process for privacy-sensitive training of a machine learning model.

Like reference numbers and designations in the various drawings indicate like elements.

### DETAILED DESCRIPTION

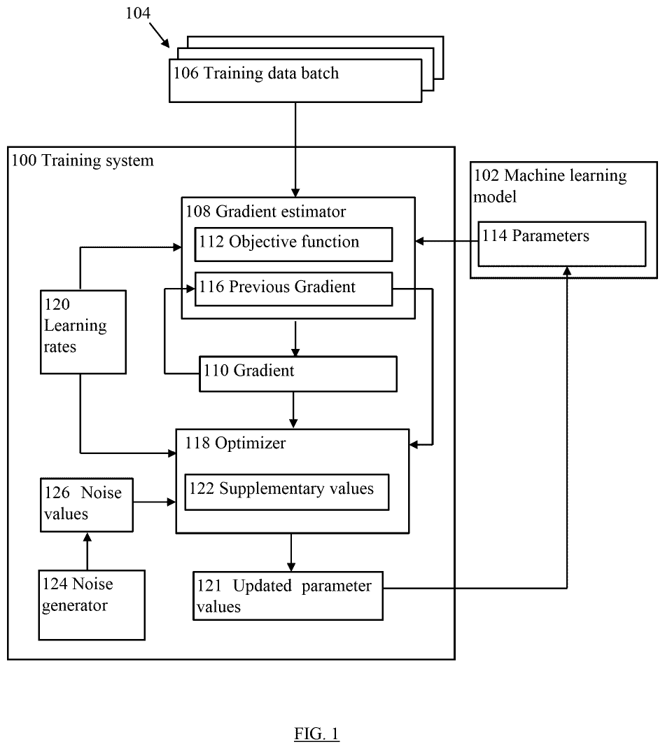

FIG. 1 shows an example training system 100 for privacy-sensitive training of a machine learning model. The training system 100 is an example of a system implemented as computer programs on one or more computers in one or more locations in which the systems, components, and techniques described below are implemented.

The training system 100 is configured to train a machine learning model 102 iteratively using batches 104 (e.g., “mini-batches”) of training data that each comprise a respective plurality of training data items, e.g., obtained by stochastic sampling of the data items from a collection of training data items.

The machine learning model 102 can, for example, be a neural network. The neural network can have any appropriate neural network architecture. For example, the neural network can include any appropriate types of neural network layers (e.g., fully-connected layers, convolutional layers, attention layers, recurrent layers, etc.) in any appropriate numbers (e.g., 5 layers, 10 layers, or 100 layers) and connected in any appropriate configuration (e.g., as a linear sequence of layers or as a directed graph of layers).

The machine learning model 102 can be configured to perform any appropriate machine learning task. In particular, the machine learning model can be configured to process any appropriate model input, e.g., including one or more of: an image, an audio waveform, a point cloud (e.g., generated by a lidar or radar sensor), a sequence of words (e.g., that form one or more sentences or paragraphs), a video (e.g., represented a sequence of video frames), or a combination thereof.

In some implementations, the number of batches can be less than or equal to \sqrt{n}, with \sqrt{n} training data items in each batch, where n is a total number of training data items, whilst still maintaining differential privacy. The systems and methods described in this specification can allow these large batch sizes to be achieved without assuming convexity of the optimization problem solved by training of the machine learning model to ensure differential privacy.

In some implementations, the number of training data items in each batch can be less than or equal to min

$$\{ {n}^{3 / 4} , \frac{{n}^{3 / 2}}{\sqrt{d}} \} ,$$

where d is the dimensionality of the machine learning model. For example, this bound can be achieved when the global minimum is in the constraint set of the optimization problem being solved. As used herein, a dimensionality of the machine learning model is the dimensionality of the input data (e.g., the number of values in an input data item) processed by the machine learning model.

In some implementations, the training system 100 can train the machine learning model 102 over a single epoch (e.g., in a single pass), i.e., in which the respective gradients for the training data items are computed only once during the training of the machine learning model 102, whilst still maintaining differential privacy. Training over a single epoch can be a key requirement in many scenarios involving differential privacy guarantees.

The objective function 112 (e.g., loss function) may compare (e.g., determine a difference between) the model output and the target output. The objective function may therefore provide a metric for the performance of the machine learning model on a machine learning task. In general, the objective function can be any objective function that is appropriate to the machine learning task that the machine learning model is being trained to perform. For example, the objective (loss) function may be a least-squares objective function, a cross-entropy objective function, a classification objective function, a regression loss function and so on. In some implementations, the objective function may be described as “M-smooth”, which means that the objective function has continuous derivatives up to order M.

Examples of machine learning tasks that the machine learning model 102 can be trained to perform are described below.

In some implementations, the machine learning model may be trained (or “pre-trained”) on a non-private dataset and then further trained (e.g. “fine-tuned”) on one or more private datasets. Alternatively or additionally, the machine learning model may be trained using multiple training datasets, with different amounts of noise and/or different batch sizes according to the sizes of the training datasets.

The training system 100 comprises a gradient estimator 108 that is configured to process the training data in each batch 104 to determine a corresponding gradient 110 of an objective function 112 with respect to parameters 114 of the machine learning model 102.

Each training data item can comprise a training input and a target output. The machine learning model 102 processes the training inputs for each of the training data items in the batch 104 in accordance with the values of the model parameters 114 to generate respective model outputs for the training data items.

To determine each gradient, the gradient estimator 108 can use the training data items in the batch to determine a “current-values” gradient of the objective function with respect to the model parameters in accordance with values of the model parameters 114 as of the current training iteration. For example, the current-values gradient can be determined by averaging respective gradients, for each training data item in the batch 104, of the objective function 112 with respect to the current values of the parameters 114 of the machine learning model 102. For example, the current-values gradient ∇̅ₜ(xₜ) for the t-th batch, with respect to the parameters 112 of the machine learning model 102 can be determined from:

$${\overline{∇}}_{t} ( {x}_{t} ) = \frac{1}{B} {\sum }_{i ∈ {B}_{t}} ∇ f ( {x}_{t} ; {d}_{i} )$$

where B denotes the number of data items dᵢ in the batch Bₜ, and ∇ is the gradient of the objective function f(xₜ; dᵢ) with respect to the parameters 112 of the machine learning model 102, evaluated using the training data item di and the current values xₜ of the parameters 112. The gradient ∇f(xₜ; dᵢ) for each training data item dᵢ can be determined by backpropagation, for example.

For the first training iteration (t=0), i.e., for the first training data batch 106, the

current-values gradient ∇̅ₜ(xₜ) can be output by the gradient estimator 108 as the corresponding gradient 110 for the batch.

For each training iteration after the first, the gradient estimator 108 can also determine a “previous-values” gradient of the objective function with respect to the model parameters in accordance with values of the model parameters as of the previous training iteration, i.e.,

$${\overline{∇}}_{t} ( {x}_{t - 1} ) = \frac{1}{B} {\sum }_{i ∈ {B}_{t}} ∇ f ( {x}_{t - 1} ; {d}_{i} )$$

The gradient estimator 108 can then combine the gradient of the objective function for the previous training iteration 116 with the current-values gradient ∇̅ₜ(xₜ) and the previous-values gradient ∇̅ₜ(xₜ₋₁)to obtain the gradient 110 for the current training iteration. For example, the gradient estimator 108 can combine the current-values gradient and the previous-values gradient to generate a corresponding delta value for the current training iteration:

$${Δ}_{t} = {η}_{t} {\overline{∇}}_{t} ( {x}_{t} ) - {η}_{t - 1} {\overline{∇}}_{t} ( {x}_{t - 1} )$$

where ηₜ is a learning rate 120 for the current training iteration and ηₜ₋₁ is a learning rate 120 for the previous iteration. The gradient 110 for the current training iteration can then be determined according to the following update rule applied to the previous gradient 116:

$${∇}_{t} = \frac{{Δ}_{t}}{{η}_{t}} - \frac{{η}_{t - 1}}{{η}_{t}} {∇}_{t - 1}$$

This update rule can be expressed equivalently as a sum over the preceding delta values:

$${∇}_{t} = \frac{1}{{η}_{t}} {\sum }_{i < t} {Δ}_{t}$$

In some implementations the current-values gradient and the previous-values gradient can be clipped, e.g., to a fixed [symbol] ₂-norm. For example, the current-values gradient ∇f(xₜ; dᵢ) for each data item dᵢ in the current batch can be clipped and the clipped current-values gradients combined to determine the current-values gradient ∇̅ₜ(xₜ)

Similarly, the previous-values gradient ∇f(xₜ₋₁; dᵢ) for each data item dᵢ in the current batch can be clipped and the clipped previous-values gradients combined to determine the previous-values gradient ∇̅ₜ₋₁(xₜ₋₁). Clipping the gradients in this way can allow the training of the machine learning model to be made private for arbitrary objective functions, e.g., non-convex objective functions.

The training system 100 further comprises an optimizer 118 configured to determine updated values 121 xₜ₊₁ of the parameters 114 of the machine learning model 102 for the training iteration based on the gradient 110 for the training iteration and the learning rate ηₜ 120 for the training iteration, i.e., a scaling factor applied to the gradient when determining the updated values. The optimizer 118 can maintain a set of supplementary values 122 zₜ of the model parameters 114 that are used in combination with the gradient 110 and the learning rate 120 to determine the updated values 121 of the model parameters 114. In some implementations, the learning rates 120 increase linearly over the training iterations, e.g., ηₜ=t.

To ensure that the training of the machine learning model is performed in a privacy-sensitive manner, the training system 100 further comprises a noise generator 124 that generates a respective plurality of noise values 126 bₜ for each iteration, which are used in determining the updated values 121 of the model parameters 114. In general, the noise values 126 are selected so that the training of the machine learning model satisfies a pre-determined differential privacy guarantee.

The noise generator 124 can generate the noise values 126 such that the noise values for successive training iterations are correlated. As one example, the noise values 126 can be generated using a binary tree mechanism. Generating the noise values 126 in this way can allow the standard deviation of the noise to grow only polylogarithmically in the number of training iterations. Binary tree mechanisms are discussed in Hubert et al. “Private and continual release of statistics”, ACM Trans. on Information Systems Security, 14(3):26:1-26:24, November 2011, and Dwork et al., “Differential privacy under continual observation”, Proc. of the Forty-Second ACM Symp. on Theory of Computing (STO ('10), pages 715-724, 2010.

The optimizer 118 can update the set of supplementary values 122 zₜ of the model parameters 114 using the update rule:

$${z}_{t + 1} = {\prod }_{𝒞} ( {z}_{t} - \frac{{η}_{t}}{β} {∇}_{t} + {b}_{t} )$$

where β is a scaling factor and [symbol] (⋅) is a projection operator, e.g., an [symbol] ₂-projection operator, onto a constraint set [symbol] for the values of the parameters 114 of the machine learning model 102. For example, the constraint set can be defined such that the [symbol] ₂-norm of the values of the machine learning model is less than or equal to a specified value (hyperradius). The scaling factor β can be derived from the smoothness of the objective function. As one example, the objective function can have continuous derivatives up to order M and the scaling factor β can have a value that is approximately equal to M\sqrt{n}, which can be appropriate if the global minimum is in the constraint set of the optimization problem being solved. As another example,

$$β \approx M \cdot max \{ \frac{{n}^{3 / 2}}{{B}^{2}} , \frac{n}{B} \} ,$$

which can be appropriate in other cases, e.g., if the global minimum is outside the constraint set.

The optimizer can determine the updated values 121 of the parameters 114 using the update rules:

$$\begin{matrix}{y}_{t + 1} = {\prod }_{𝒞} ( {x}_{t} - \frac{1}{β} {∇}_{t} + \frac{{η}_{t}}{β} {b}_{t} ) \\ {x}_{t + 1} = ( 1 - {τ}_{t + 1} ) {y}_{t + 1} + {τ}_{t + 1} {z}_{t + 1}\end{matrix}$$

where τₜ₊₁ is an interpolation parameter, which can, for example, be determined based on the learning rates 120, e.g., τₜ=ηₜ/Σ_{τ≤t}η_{τ}.

The initial values x₀ of the parameters of the machine learning model and the initial values of the supplementary values z₀ can be zero, for example.

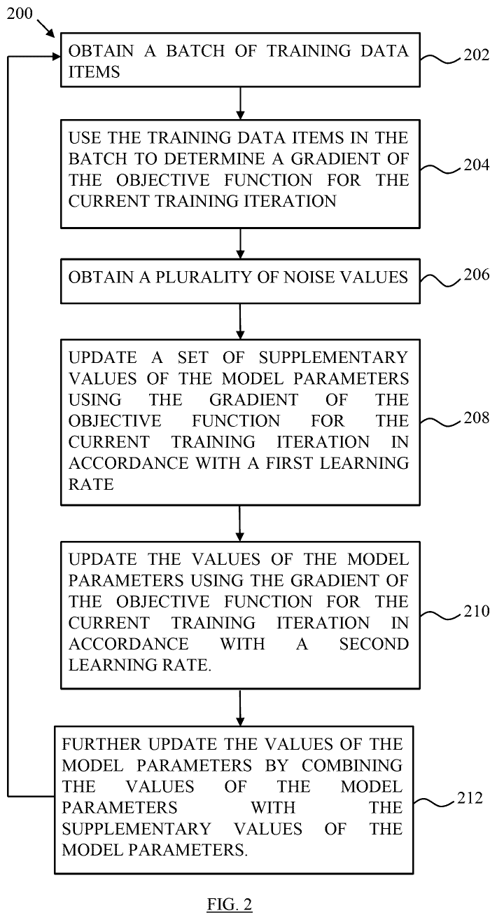

FIG. 2 is a flow diagram of an example process 200 for privacy-sensitive training of a machine learning model. For convenience, the process 200 will be described as being performed by a system of one or more computers located in one or more locations. For example, a training system, e.g., the training system 100 of FIG. 1, appropriately programmed in accordance with this specification, can perform the process 200.

The machine learning model comprises a set of model parameters. The training system can perform a plurality of training iterations to update values of the machine learning model to optimize an objective function.

The training system can obtain a batch of training data items for the current training iteration (202). Each training data item can comprise a training input and a target output, as described above in connection with FIG. 1.

The training system uses the training data items in the batch to determine a gradient of the objective function for the current training iteration (204).

The training system obtains a plurality of noise values (206).

The training system updates a set of supplementary values of the model parameters using the gradient of the objective function for the current training iteration in accordance with a first learning rate (208). Using the training data items in the batch to determine the gradient of the objective function for the current training iteration can comprise (e.g., for each of the training iterations except the first) determining the gradient of the objective function for the current training iteration by updating the gradient of the objective function for the previous training iteration using the training data items in the batch for the current training iteration.

The training system updates the values of the model parameters using the gradient of the objective function for the current training iteration in accordance with a second learning rate that differs from (e.g., is less than) the first learning rate (210).

The training system then further updates the values of the model parameters by combining the values of the model parameters with the supplementary values of the model parameters (212).

Steps 202-212 of the process 200 can then be repeated by the training system, e.g., until the machine learning model achieves a desired performance as measured by the objective function, or after a predetermined number of training iterations have been performed.

A few examples of machine learning tasks that can be performed by the machine learning model are described in more detail next. The machine learning model can be trained to perform one or more of the machine learning tasks using the systems and methods described in this specification.

In some implementations, the machine learning model is configured to process a model input that represents the pixels of an image to generate a classification output. The classification output can include a respective score for each class in a set of classes, where the score for a class defines a likelihood that the image is included in the class. A few examples of classification tasks that can be performed by the machine learning model are described next.

In one example, the machine learning model performs an object classification task. In this example, each class in the set of classes corresponds to a respect category of object, and an image is included in a class if it depicts an object in the object category corresponding to the class. Examples of object categories include, e.g., vehicle, pedestrian, bicyclist, etc.

In another example, the machine learning model can perform an action classification task. In this example, each class in the set of classes corresponds to a respective action, and an image is included in a class if it depicts a person performing the action corresponding to the class. Examples of actions include, e.g., sitting, standing, running, walking, etc.

In another example, the machine learning model can process medical images (e.g., ultrasound images, computed tomography (CT) images, or magnetic resonance (MR) images) to perform a medical classification task. In this example, each class in the set of classes corresponds to a respective medical category, and an image is included in a class if it depicts tissue that exhibits characteristics of the medical category corresponding to the class. Examples of medical categories include, e.g., cancerous tissue and non- cancerous tissue.

In another example, the machine learning model can process biometric images (e.g., images showing an eye of a person) to perform an identity classification task. In this example, each class in the set of classes can correspond to a respective person, and a biometric image is included in a class if it depicts (at least part of) a person corresponding to the class.

In some implementations, the machine learning model is configured to process a model input that represents audio samples in an audio waveform to perform speech recognition, i.e., to generate an output that defines a sequence of phonemes, graphemes, characters, or words corresponding to the audio waveform.

In some implementations, the machine learning model is configured to process a model input that represent words in a sequence of words to perform a natural language processing task, e.g., topic classification or summarization. To perform topic classification, the machine learning model generates an output that includes a respective score for each topic category in a set of possible category categories (e.g., sports, business, science, etc.). The score for a topic category can define a likelihood that the sequence of words pertains to the topic category. To perform summarization, the machine learning model generates an output that includes an output sequence of words that has a shorter length than the input sequence of words and that captures important or relevant information from the input sequence of words.

In some implementations, the machine learning model performs a machine translation task, e.g., by processing a model input that represents a sequence of text, e.g., a sequence of words, phrases, characters, or word pieces, in one language, to generate an output that can be a translation of the sequence of text into another language, i.r., a sequence of text in the other language that is a translation of the input sequence of text. As a particular example, the task can be a multi-lingual machine translation task, where the machine learning model is configured to translate between multiple different source language—target language pairs. In this example, the source language text can be augmented with an identifier that indicates the target language into which the machine learning model should translate the source language text.

In some implementations, the machine learning model is configured to perform an audio processing task. For example, if the model input represents a spoken utterance, then the output generated by the machine learning model can be a score for each of a set of pieces of text, each score representing an estimated likelihood that the piece of text is the correct transcript for the utterance. As another example, if the model input represents a spoken utterance, the output generated by the machine learning model can indicate whether a particular word or phrase (“hotword”) was spoken in the utterance. As another example, if the model input represents a spoken utterance, the output generated by the machine learning model can identify the natural language in which the utterance was spoken.

In some implementations, the machine learning model is configured to perform a natural language processing or understanding task, e.g., an entailment task, a paraphrase task, a textual similarity task, a sentiment task, a sentence completion task, a grammaticality task, and so on, that operates on a set of model inputs representing text in some natural language.

In some implementations, the machine learning model is configured to perform a text to speech task, where the model input represents text in a natural language or features of text in a natural language and the model output is a spectrogram, a waveform, or other data defining audio of the text being spoken in the natural language.

In some implementations, the machine learning model is configured to perform a health prediction task, where the model input represents data derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

In some implementations, the machine learning model is configured to perform a text generation task, where the model input represents a sequence of text, and the output is another sequence of text, e.g., a completion of the input sequence of text, a response to a question posed in the input sequence, or a sequence of text that is about a topic specified by the first sequence of text. As another example, the model input can represent data other than text, e.g., an image, and the output sequence can be text that describes the data represented by the model inputs.

In some implementations, the machine learning model is configured to perform a genomics task, where the model input represents a fragment of a DNA sequence or other molecule sequence and the output includes, e.g., a promoter site prediction, a methylation analysis, a prediction for functional effects of non-coding variants, and so on.

In some implementations, the machine learning model is configured to perform a point cloud processing task, e.g., where the model input represents a point cloud (e.g., generated by a lidar or radar sensor) and the model output characterizes, e.g., a type of object represented by the point cloud.

In some implementations, the machine learning model is configured to perform a combination of multiple individual machine learning tasks, e.g., two or more of the machine learning tasks mentioned above. For example, the machine learning model can be configured to perform multiple individual natural language understanding tasks, with the model inputs processed by the machine learning model including an identifier for the individual natural language understanding task to be performed on model input.

Some further examples of machine learning tasks that the machine learning model may be trained to perform will now follow.

The task that the trained machine learning model, or part thereof, is used to perform may generally correspond to a type of the training data item. For example where the training data item comprises an audio data item, an image data item, a multimodal data item, a text data item, or a graph data item, the trained machine learning model, or part thereof, may be used, correspondingly, to process input data comprising audio data, image data, multimodal data, text data, or graph data respectively to perform an audio signal processing task, an image processing task, a multimodal processing task, a text processing task, or a graph processing task.

As one example, the training data item, and input data, may comprise audio data representing values of a digitized audio waveform, e.g. a time sequence of waveform-representing elements. Such a representation may comprise, e.g., samples representing digitized amplitude values of the waveform or a time-frequency domain representation of the waveform such as a STFT (Short-Term Fourier Transform) or MFCC (Mel-Frequency Cepstral Coefficient) representation. The audio waveform may comprise e.g. a speech waveform or a waveform of a sound, e.g. a captured sound. Objects in the audio waveform may comprise e.g. speech elements such as words, syllables, or phonemes; or events or other distinguishable audio objects in the sound.

The audio signal processing task may comprise, e.g.: processing audio data representing speech to provide output data that detects words or phonemes in the speech or categorizes words or phonemes in the speech into one or more of a plurality of categories; or processing audio data representing a sound to provide output data, e.g. likelihood data, that detects presence of a particular sound or audio object or event in the sound e.g. in a hotword detection or identification task; or processing audio data representing a sound to provide output data that categorizes a content of the sound into one or more of a plurality of categories (i.e. classifying a sound). In some further examples the audio signal processing task may comprise, e.g.: an identification or classification task such as a speech or sound recognition task, e.g. a hotword detection or identification task, a speaker or natural language classification task, or an audio tagging task, in which case the output data may comprise a category score or tag for the audio or for a segment of the audio; or a similarity determination task e.g. an audio copy detection or search task, in which case the output data may comprise a similarity score.

In some implementations the training data item, and input data, may comprise sensor data representing values of a digitized sensor waveform i.e. a sensor other than an audio sensor may be used to obtain the digitized waveform. The digitized sensor waveform may be treated similarly to a digitized audio waveform. The sensor data may be generated by sensors configured to monitor the real-world state, condition or environment of a physical system, e.g. of a mechanical or electronic physical system or machine, e.g. sensing force, pressure, movement, temperature, or vibration. The objects may comprise events or other distinguishable objects in the sensor data, or conditions of the physical system. The signal processing task may be to process the input data to provide output data that identifies the presence of one or more of the events, objects, conditions or environments.

As another example, the training data item, and input data, may comprise image data representing a still or moving image, i.e. an image or video, e.g. an image or video that has been captured using a camera. Elements of the image data may comprise monochrome or color pixels of the image or video. As defined herein an “image” includes a point cloud e.g. from a LIDAR system, and a “pixel” includes a point of the point cloud. Similarly “video” includes a time sequence of point clouds. Objects in the image or video may comprise objects, e.g. physical objects, represented by the image or video.

The image processing task may comprise, e.g.: processing the image data to provide output data that identifies the location of one or more specified or unspecified objects in the image or video, e.g. output data that defines one or more object bounding shapes or boxes; or processing the image data to provide output data that segments pixels of the image or video into regions that represent one or more objects in the image or video signal; or processing the image data to provide output data that categorizes a content of the image or video into one or more of a plurality of categories; or processing the image data to provide output data that predicts depth values for pixels of the image or video. A task that segments the pixels may be e.g. a semantic segmentation task that associates each pixel with a category representing a class of objects, or an instance segmentation task that associates each pixel with a category representing an instance of an object, i.e. to distinguish between different instances of the same category of object.

Where the image data comprises pixels of a video the image processing task may comprise, e.g.: processing the image data to provide output data that identifies the location of one or more actions represented in the video; or processing the image data to provide output data that categorizes one or more actions, e.g. gestures, represented in the video into one or more of a plurality of categories.

In general, the image processing task may include any sort of image processing or computer vision task such as an image classification or scene recognition task, an image segmentation task e.g. a semantic or instance segmentation task, an object localization or detection task, or a depth estimation task. When performing such a task the input data may be derived from pixels of the image.

For an image classification or scene recognition task the output may comprise a classification output providing a score for each of a plurality of image or scene categories e.g. representing an estimated likelihood that the image data or an object represented in the image data, or that an action within image data representing a video, belongs to a category of a set of categories.

For an image segmentation task the output may comprise, for each pixel, an assigned segmentation category or a probability that the pixel belongs to a segmentation category, e.g. to an object or action represented in the image or video. For an object localization or detection task the output may comprise data defining coordinates of a bounding box or region for one or more objects represented in the image. Such a bounding box or region may be defined in two, three or more dimensions (time counting as a dimension). For a depth estimation task the output may comprise, for each pixel, an estimated depth value. The output may define a continuous value or it may define a probability distribution over discrete depth value buckets, such that the output pixels define a (spatial 3D) depth map for the image. Such tasks may also contribute to higher level tasks, e.g. to object tracking across video frames; or to gesture recognition i.e. recognition of gestures that are performed by entities depicted in a video. As another example, the image processing task may include an image keypoint detection task in which the output comprises the coordinates of one or more image keypoints, such as landmarks of an object represented in the image, e.g. a human pose estimation task in which the keypoints may define the positions of body joints. A further example is an image similarity determination task, in which the output may comprise a value representing a similarity between two images, e.g. as part of an image search task.

In some applications, the image data item may be a medical image, such as an X-ray image, CAT scan or MRI image. For example, the machine learning model may be trained to output segmentation data indicating the location(s) of cancerous matter in the medical image

As another example, the training data item, and input data, may comprise text data; elements of the text data may comprise e.g. sentences, words, or parts of words e.g. wordpieces. The text processing task may comprise, e.g.: a part-of-speech tagging task, in which case the output data may comprise e.g. a category score or tag for the text or for a segment of the text; or a dependency parsing task, in which case the output data may comprise data representing a dependency parse of the text; or a text segmentation task, in which case the output data may comprise data that associates elements of the text with one or more of a plurality of categories for the text. Other example tasks include an identification or classification task, or a similarity determination task, e.g. to generate a category score, a similarity score, or a tag as described above; or a machine translation task. Another example task is a next-word (or token) or missing word (or token) prediction task.

In some implementations, the machine learning model is a language model neural network, e.g. a language generation neural network. The language generation neural network may comprise a sequence-to-sequence model that receives an input string of natural or computer language text tokens and generates an output string of one or more natural or computer language text tokens, e.g. autoregressively, a token at a time. In general, any language generation neural network may be used, e.g. an auto-regressive language generation neural network, or a language generation neural network that does not rely on an auto-regressive model, such as a recurrent language generation neural network or a denoising auto-encoder based language model (e.g. arXiv:2112.06749). The language generation neural network may, for example, be trained on a next-word (or next-token) or missing word (or missing token) prediction task, e.g. using an objective function that compares a probability distribution for the next/missing word or token in an input string predicted by the machine learning model with a ground-truth next/missing word or token obtained from the string.

In some implementations, the language model neural network processes the input token string to generate a score distribution, e.g., a probability distribution, that assigns a respective score (probability), to each text token in the token vocabulary. The language model neural network can then select a text token for the output token string from the token vocabulary using the score distribution. For example a highest-scoring text token may be selected, or a text token may be sampled from the distribution, e.g., using nucleus or other sampling.

A language model neural network can be made to perform a particular task by providing a natural language description of the desired response as an input or “prompt”. The prompt may be a few-shot prompt where a few, e.g., 1 to 10, examples of a query and an example output are provided in the text prior to the actual query. Instead or in addition, a language model neural network may be “fine-tuned” to perform a particular task, by obtaining a pre-trained language model neural network trained on a large corpus of examples as previously described and then further training part of or all of the language model neural network on a relatively small number of examples particular to the type of task that is to be performed. The fine-tuning may, for example, be performed in a differentially private manner to avoid the examples from being extracted from the trained language model neural network.

Some implementations of the methods/systems described herein use large language model/language generation neural networks (e.g. LLMs). Such a large language model/language generation neural network may have greater than 1 billion, 10 billion or 100 billion trainable/trained parameters. It may have been trained on greater than 10 billion, 100 billion or 1000 billion words or tokens representing words.

In some implementations, the “language” of the language model is not a natural language such (e.g. English), but may instead be a text-based encoding describing an entity or class of entities, e.g. a chemical or biological entity, such as a chemical structure or molecule. For example, the text-based encoding may be a sequence of tokens that defines a molecule or protein, e.g. a sequence specifying an arrangement of atoms or chemical functional groups in a molecule, or the amino acid residues of a protein. The language model may be referred to as a chemical and/or biological language model in such cases. The input for the language generation neural network may therefore be an input string defining a chemical (e.g. protein) structure and the output may be an output string defining a different chemical structure from the input string. The strings may be in the Simplified Molecular Input Line Entry System, SMILES, format, for example.

As another example, the training data item, and input data, may comprise multimodal data. In general such multimodal data is a combination of two or more different types of data, where the different types of data represent the same or overlapping objects using the different modalities (types). As one example the multimodal data may comprise audio-visual data, comprising a combination of pixels of an image or of video and audio data representing values of a digitized audio waveform. As another example the multimodal data may comprise a combination of i) text data representing text in a natural language and ii) pixels of an image or of video or audio data representing values of an audio waveform. Elements of the multimodal data may correspond to elements of the data types making up the combination. Optionally, but not necessarily, when processing multimodal data the data may be mapped into a common embedding space.

In general, the multimodal processing task may correspond to any of the tasks previously described for any of the types of data making up the multimodal combination. For example, an accuracy of the previously described tasks may be increased when the task is applied to multimodal data combining the data for which the task has been previously described and another type of data. For example detection or classification of an object or event may be improved when data of multiple different types (modalities) is processed.

As one particular example, where the multimodal data comprises audio-visual data the multimodal processing task may comprise: processing the combination, i.e. the image/video and audio, to provide output data that detects presence of a particular multimodal object or event in the combination (e.g. to identify a phoneme or viseme when lip reading); or processing the combination to provide output data that categorizes the combination into one or more of a plurality of categories, e.g. by defining a score for each category of a plurality of possible categories for the combination. As another particular example, where the multimodal data comprises a combination of text data and image or video or audio data the multimodal processing task may comprise processing the combination to provide output data that defines whether the image or video or audio waveform is described by the text, e.g. by a particular caption, e.g. by defining a score for the text or caption.

Some example multimodal machine learning models with which the techniques described herein may be used include: Flamingo (Alayrac et al. arXiv:2204.14198); ALIGN (Jia et al., arXiv:2102.05918); PaLI (Chen et al. arXiv:2209.06794); and PaLI-X (Chen et al. arXiv:2305.18565).

As another example the training data item, and input data, may comprise graph data; in such implementations the machine learning models described herein may comprise graph neural networks. In general the graph data may define a graph structure having a set of nodes with associated node feature vectors connected by edges which may have associated edge feature vectors. A graph may, but need not be, defined by an adjacency matrix e.g. where N is the number of nodes, an N×N matrix defining which nodes are connected by edges. Elements of the graph data may comprise e.g. nodes or edges of a graph represented by the graph data.

A graph may represent a real-world physical system; merely as some examples, a mechanical structure in which bodies are connected by joints, or a structure of a molecule such as a drug molecule. The objects may comprise e.g. physical bodies or parts of a molecule e.g. chemical moieties. The graph processing task may comprise e.g.: characterizing a physical entity represented by the graph to provide output data that defines a predicted stability of the physical structure or molecule, or the binding affinity of a molecule represented by the graph with another molecule e.g. to identify a drug candidate (which may then be evaluated by synthesizing the molecule and e.g. testing the molecule in vitro or in vivo). The predicted stability of the physical structure may be used e.g. to design or evaluate a structure; the result may then be used to construct a structure to the design. As another example the graph may be a scene graph that represents a scene; the scene graph may have been generated from a captured real-world image. The graph processing task may then comprise generating output data that identifies or classifies the scene or one or more objects within the scene e.g. to facilitate object/scene editing or information extraction for scene interpretation.

In some implementations, the machine learning task may comprise any one or more of:
(i) Data item classification, i.e. assigning an input data item (e.g. image) to one (or more) of set of classes based on content of the data item. Note that “content” here means content defined by pixelated intensity values in the case that the data item is an image, or defined by amplitude values in the case that the media item is a sound.
(ii) Captioning (generating a caption, such as a sequence of tokens selected from a vocabulary) describing the content of the data item.
(iii) Question answering, e.g., visual question answering (VQA), of generating an answer which is an appropriate response to a question about the data item;
(iv) A segmentation task of identifying a (proper) subset of the data item having specific properties, e.g. for a data item which is an image, “a penguin in the foreground”, “cancerous material”; or for a data item which is a sound signal, “a child crying after a dog has barked”).
(v) An agent control task of generating control data for an agent in an environment (e.g. an electro-mechanical agent such as a robot) based on a data item describing the environment (e.g. received sensor data, such as an image of an environment captured by a camera).

Some implementations may be used to perform neural machine translation. Thus in some implementations the data item comprises tokens that represent words, wordpieces, or characters in a first natural language and the downstream task is to generate output tokens that represent words, wordpieces or characters in a second, different natural language. That is, the data item may represent input text in the first language and the output sequence may represent a translation of the input text into the second language.

Some implementations may be used for automatic code generation. For example the data item can comprise input tokens that represent words, wordpieces or characters in a first natural language and the downstream task can be to generate output tokens that represent instructions in a computer programming or markup language, or instructions for controlling an application program to perform a task e.g. build a data item such as an image or web page.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them. Thus a system, artificial neural network, or trained artificial neural network as described herein, can be implemented in hardware using electronic circuitry, e.g. in a physical box. Similarly computer code as described herein can be code to emulate such hardware or code for a hardware description language.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.c., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers for privacy-sensitive training of a machine learning model, the machine learning model comprising a set of model parameters, values of which are updated over a plurality of training iterations to optimize an objective function, the method comprising, at each of the training iterations:
obtaining a respective batch of training data items;
using the training data items in the batch to determine a gradient of the objective function for the current training iteration;
obtaining a respective plurality of noise values; and
updating the values of the model parameters using the gradient of the objective function for the current training iteration and the plurality of noise values, and wherein updating the values of the model parameters using the gradient of the objective function for the current training iteration comprises:
updating a set of supplementary values of the model parameters using the gradient of the objective function for the current training iteration in accordance with a first learning rate;
updating the values of the model parameters using the gradient of the objective function for the current training iteration in accordance with a second learning rate that differs from the first learning rate; and
further updating the values of the model parameters by combining the values of the model parameters with the supplementary values of the model parameters.

2. The method of claim 1, wherein for each training iteration except the first, the set of supplementary values of the model parameters that is updated in the current training iteration is the set of supplementary values of the model parameters following the update made during the previous training iteration.

3. The method of claim 1, wherein using the training data items in the batch to determine a gradient of the objective function for the current training iteration comprises, at each of the training iterations except the first:
determining the gradient of the objective function for the current training iteration by updating the gradient of the objective function for the previous training iteration using the training data items in the batch for the current training iteration.

4. The method of claim 1, wherein using the training data items in the batch to determine the gradient of the objective function for the current training iteration comprises:
using the training data items in the batch to determine a first gradient of the objective function with respect to the model parameters in accordance with values of the model parameters as of the current training iteration; and
wherein determining the gradient of the objective function for the current training iteration by updating the gradient of the objective function for the previous training iteration using the training data items in the batch comprises:
using the training data items in the batch to determine a second gradient of the objective function with respect to the model parameters in accordance with values of the model parameters as of the previous training iteration; and
combining the gradient of the objective function for the previous training iteration with the first gradient and the second gradient to obtain the gradient for the current training iteration.

5. The method of claim 4, wherein using the training data items in the batch to determine the first gradient of the objective function comprises:
for each training data item in the batch of training data items, determining a corresponding current-values gradient of the objective function with respect to the model parameters when the objective function is evaluated for a model output generated by the machine learning model processing the training data item in accordance with values of the model parameters as of the current training iteration; and
determining the first gradient by combining the current-values gradients of the objective function corresponding to each of the training data items in the batch.

6. The method of claim 5, wherein using the training data items in the batch to determine the second gradient of the objective function comprises:
for each training data item in the batch of training data items, determining a corresponding previous-values gradient of the objective function with respect to the model parameters when the objective function is evaluated for a model output generated by the machine learning model processing the training data item in accordance with values of the model parameters as of the previous training iteration; and
determining the second gradient by combining the previous-values gradients of the objective function corresponding to each of the training data items in the batch.

7. The method of claim 6, wherein:
determining the first gradient by combining the current-values gradients of the objective function corresponding to each of the training data items in the batch comprises:
clipping the current-values gradients of the objective function corresponding to each of the training data items in the batch; and
determining the first gradient by combining the clipped current-values gradients of the objective function corresponding to each of the training data items in the batch, and
determining the second gradient by combining the previous-values gradients of the objective function corresponding to each of the training data items in the batch comprises:
clipping the previous-values gradients of the objective function corresponding to each of the training data items in the batch; and
determining the second gradient by combining the clipped previous-values gradients of the objective function corresponding to each of the training data items in the batch.

8. The method of claim 1, wherein updating the set of supplementary values of the model parameters further comprises combining the supplementary values of the model parameters with the plurality of noise values.

9. The method of claim 1, further comprising determining corresponding reduced noise values for each of the plurality of noise values, each reduced noise value being less than the corresponding noise value, and wherein updating the values of the model parameters using the plurality of noise values comprises combining the values of the model parameters with the reduced noise values.

10. The method of claim 9, wherein a ratio of each reduced noise value to the corresponding noise value is less than or equal to a ratio of the second learning rate for the training iteration to the first learning rate for the training iteration.

11. The method of claim 1, wherein the updating of the supplementary values of the model parameters is performed in parallel with the updating of the values of the model parameters.

12. The method of claim 1, wherein the gradients for each training iteration are determined by one or more client devices using values of the model parameters provided to the one or more client devices by a server.

13. The method of claim 3, wherein the gradients for each training iteration are determined by one or more client devices using values of the model parameters provided to the one or more client devices by a server, the method further comprising:
at the one or more client devices, determining a noisy gradient update by combining the first gradient and the second gradient with the plurality of noise values, and
wherein using the training data items in the batch to determine the gradient of the objective function for the current training iteration comprises:
determining the gradient for the current training iteration by combining the gradient for the previous training iteration and the noisy gradient update.

14. The method of claim 13, further comprising sending the noisy gradient update to the server from the one or more client devices, and at the server, determining the gradient for the current training iteration by combining the gradient for the previous training iteration and the noisy gradient update.

15. The method of claim 1, wherein the noise values are selected so that the training of the machine learning model satisfies a pre-determined differential privacy guarantee.

16. The method of claim 1, wherein the respective pluralities of noise values for successive training iterations are correlated.

17. The method of claim 1, wherein the noise values are instantiated using a binary tree mechanism.

18. The method of claim 1, wherein the machine learning model is trained over a single epoch.

19. One or more non-transitory computer storage media storing instructions that when executed by one or more computers cause the one or more computers to perform operations for privacy-sensitive training of a machine learning model, the machine learning model comprising a set of model parameters, values of which are updated over a plurality of training iterations to optimize an objective function, the operations comprising, at each of the training iterations:
obtaining a respective batch of training data items;
using the training data items in the batch to determine a gradient of the objective function for the current training iteration;
obtaining a respective plurality of noise values; and
updating the values of the model parameters using the gradient of the objective function for the current training iteration and the plurality of noise values, and wherein updating the values of the model parameters using the gradient of the objective function for the current training iteration comprises:
updating a set of supplementary values of the model parameters using the gradient of the objective function for the current training iteration in accordance with a first learning rate;
updating the values of the model parameters using the gradient of the objective function for the current training iteration in accordance with a second learning rate that differs from the first learning rate; and
further updating the values of the model parameters by combining the values of the model parameters with the supplementary values of the model parameters.

20. A system comprising:
one or more computers; and
one or more storage devices communicatively coupled to the one or more computers, wherein the one or more storage devices store instructions that, when executed by the one or more computers, cause the one or more computers to perform operations for privacy-sensitive training of a machine learning model, the machine learning model comprising a set of model parameters, values of which are updated over a plurality of training iterations to optimize an objective function, the operations comprising, at each of the training iterations:
obtaining a respective batch of training data items;
using the training data items in the batch to determine a gradient of the objective function for the current training iteration;
obtaining a respective plurality of noise values; and
updating the values of the model parameters using the gradient of the objective function for the current training iteration and the plurality of noise values, and
wherein updating the values of the model parameters using the gradient of the objective function for the current training iteration comprises:
updating a set of supplementary values of the model parameters using the gradient of the objective function for the current training iteration in accordance with a first learning rate;
updating the values of the model parameters using the gradient of the objective function for the current training iteration in accordance with a second learning rate that differs from the first learning rate; and
further updating the values of the model parameters by combining the values of the model parameters with the supplementary values of the model parameters.
